(19) United States
(12) Patent Application Publication
(10) Pub. No.: US 2026/0219866 A1
(43) Pub. Date: Jul. 30, 2026

(54) Processor Environment Agnostic Firmware Management Operation Including a Learning-Based BIOS Update Operation

(71) Applicant: Dell Products L.P., Round Rock, TX (US)

(72) Inventors: Karunakar Poosapalli, Telangana (IN); Thippeswamy D R, Tumkur (IN); Shekar Babu Suryanarayana, Bangalore (IN)

(21) Appl. No.: 19/039,146

(22) Filed: Jan. 28, 2025

(51) Int. Cl. G06F 8/65; G06F 21/57

(52) U.S. Cl. CPC G06F 8/65; G06F 21/572

(57) ABSTRACT

A firmware management operation. The firmware management operation includes providing an information handling system with a distributed unified BIOS; identifying a processor environment installed on an information handling system from a plurality of processor environments, the processor environment comprising a processor architecture; and, performing a learning-based BIOS update operation, the learning-based BIOS update operation determining whether a BIOS update is available and if so updating the distributed unified BIOS during a first power on of the information handling system, the learning-based BIOS update operation being processor environment agnostic.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed unified BIOS; identifying a processor environment installed on an information handling system from a plurality of processor environments, the processor environment comprising a processor architecture; and, performing a learning-based BIOS update operation, the learning-based BIOS update operation determining whether a BIOS update is available and if so updating the distributed unified BIOS during a first power on of the information handling system, the learning-based BIOS update operation being processor environment agnostic.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed unified BIOS; identifying a processor environment installed on an information handling system from a plurality of processor environments, the processor environment comprising a processor architecture; and, performing a learning-based BIOS update operation, the learning-based BIOS update operation determining whether a BIOS update is available and if so updating the distributed unified BIOS during a first power on of the information handling system, the learning-based BIOS update operation being processor environment agnostic.

In another embodiment the invention relates to a computer-readable storage medium embodying computer program code, the computer program code comprising computer executable instructions configured for: providing an information handling system with a distributed unified BIOS; identifying a processor environment installed on an information handling system from a plurality of processor environments, the processor environment comprising a processor architecture; and, performing a learning-based BIOS update operation, the learning-based BIOS update operation determining whether a BIOS update is available and if so updating the distributed unified BIOS during a first power on of the information handling system, the learning-based BIOS update operation being processor environment agnostic.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified block diagram of Authenticated Basic Input/Output System (BIOS) Interface services implemented within a cloud computing environment;

FIGS. 6a and 6b, generally referred to as FIG. 6, are a simplified process flow diagram of a learning-based BIOS update operation; and,

FIGS. 7a, 7b and 7c, generally referred to as FIG. 7, are a simplified process flow diagram showing a context based bootable security policy management operation.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the disclosure reflect an appreciation that it can be challenging to maintain up to date BIOS versions for information handling systems, especially for customer factory interface (CFI) type information handling systems. Various aspects of the present disclosure include an appreciation that maintaining up-to-date BIOS versions is important for ensuring security and performance. Various aspects of the disclosure reflect an appreciation that often CFI type information handling systems are shipped directly to customers with rapid storage technology (RTS) BIOS versions, but the orders to ship may be delayed by several months to up to a year. During this interval, numerous security vulnerability updates, processor environment specific reference code updates, and micro-updates are typically released. This delay can result in a first power-on at the customer's site encountering multiple vulnerabilities, potentially compromising the platform boot. Recovering from such compromises can be extremely costly, especially when some vulnerabilities block subsequent firmware updates.

Various aspects of the present disclosure include an appreciation that it would be desirable to provide a smart update mechanism which executes during the first power-on to the operating system (OS). Incorporating all stable modular updates into the platform before the system boots to the operating system can ensure a seamless and secure user experience. Various aspects of the present disclosure include an appreciation that such a proactive approach can significantly mitigate the risks associated with outdated firmware and enhance the overall robustness and reliability of the system.

Various aspects of the disclosure reflect an appreciation that before the first power on takes place at a customer's site, there is no method to remediate all the open vulnerabilities available at that point in time. Once the system connects to the network on the customer site, it is possible for the customer box to be exposed to multiple vulnerabilities as the patches required to counter them would not have been applied before the first power on.

Various aspects of the disclosure reflect an appreciation that when an enterprise platform is ready to be sold to customers, there are multiple revisions/updates that are already available for the platform. Various aspects of the disclosure reflect an appreciation that the multiple revisions/updates can require multiple forced firmware updates along with re-boots. This issue often occurs because the time taken to stress test a BIOS image is between a month to a quarter. At the time of sale, there are already numerous updates available in the pipeline. The overall effort to force update a system and perform reboots is time consuming and leads to a bad user experience.

Various aspects of the disclosure reflect an appreciation that it would be desirable to provide customer factory interface type information handling systems which allow modular updates to be deployed as a patch and to update the targeted firmware in a lightweighted manner.

A system and method for performing a learning-based BIOS update operation. In certain embodiments, the learning-based BIOS update operation uses an artificial intelligence (AI) powered smart BIOS. In certain embodiments, the AI powered smart BIOS addresses the CFI issue by automatically connecting a CFI type information handling system to the cloud during the first power on to check for any modular updates. The BIOS connects to the cloud before the system boots to the operating system and checks if there are any modular updates/patches that are available for the equivalent BIOS version or higher. If found, no forced update needs to occur and only the needed patches/modular updates are applied to the current firmware to ensure that the system is fully up to date.

In certain embodiments, when performing the learning-based BIOS update operation, an enterprise system (e.g., a CFI type information handling system) connects to the cloud before the system boots to the operating system with the help of a light network stack. Next, the system checks the cloud for any pending modular updates for a version that is equivalent to the current BIOS version. Next, the system only checks for the patches equivalent to the BIOS of the enterprise system. If any update is pushed by the system supplier, a lightweighted modular update is pushed to the system and is used to boot the system.

In certain embodiments, a firmware CFI learning model connects to the CFI type information handling system. During the system lifecycle, the firmware CFI learning model identifies the factory shipped BIOS version, all firmware updates, security updates, etc. A smart CFI Firmware module prepares a smart update mechanism before the first power-on to the operating system. By incorporating all stable modular updates into the CFI type information handling system before the system boots to the operating system, the learning-based BIOS update operation ensures a seamless and secure user experience. Such a proactive approach significantly mitigates risks associated with outdated firmware and enhances the overall robustness and reliability of the system.

In certain embodiments, a cloud learning model identifies released firmware components and prepares the system with a custom bridge to fix vulnerabilities, potentially compromising the platform boot and recovering especially when some vulnerabilities block subsequent firmware updates.

Various aspects of the disclosure reflect an appreciation that operating system supplier security policy enforcement often requires that clients update their security certificates in accordance with new policy guidelines. However, merely updating the certificates is insufficient; clients also need to rebuild the existing bootloader images to be compliant with the new policy guidelines. Various aspects of the disclosure reflect an appreciation that known information handling systems often lack a secure environment to dynamically assess the platform security, operating system boot context, and new policy requirements. This assessment is important for rebuilding the boot images to ensure seamless operating system booting without interruption.

Various aspects of the disclosure reflect an appreciation that with known information handling systems, customers need to log in with administrative privileges and access a Unified Extensible Firmware Interface (UEFI) shell often by mounting a universal serial bus (USB) type drive to push the certificates and copy the new bootloader. This method is highly vulnerable and lacks an industry-standard secure approach to rebuild boot images with the necessary context, facilitating a secure operating system boot.

Various aspects of the disclosure reflect an appreciation that with known information handling systems, when the operating system supplier updates bootloaders and certificates, they provide the patch to push the new certificate and bootloaders to the system, often via a secure boot data bases, where this path can be vulnerable.

Various aspects of the disclosure reflect an appreciation that with known information handling systems, when there is a new operating system supplier policy patch updated to system platforms, there can be system crash issues (often referred to as blue screen of death (BSOD)) possibly due to incompatible bootloaders or certificate issues. Various aspects of the disclosure reflect an appreciation that with known information handling systems, updating the new operating system supplier policy to a large number of systems (e.g. greater than 1000 systems) is difficult as there is no seamless secure deployment firmware support available.

Various aspects of the disclosure reflect an appreciation that with known information handling systems, when updating the new operating system supplier policy (e.g., a 7B policy), operating system boot fails can occur due to policy bootloaders, resulting in system crashes due to old certificates and binaries. With this situation, booting from a USB device with newly signed bootloaders and certificates is often required. However, this process can expose the USB device as a vulnerability as there is no cloud security involvement.

Various aspects of the disclosure reflect an appreciation that with known information handling systems, updating the new operating system supplier policy (e.g., a 7B policy), only controls the operating system bootable binaries and certificates; but does not ensure the trust factor for third party vendor binaries/certificates associated with component operating system boot binaries such as camera components, USB components, sensor components, computer vision components, trusted platform module components, etc. Various aspects of the present disclosure include an appreciation that inaccurate installation of these component boot binaries can result in operating system hang conditions which can expose a device data path. Various aspects of the disclosure reflect an appreciation that component security models often require execution of operating system level runtime security execution, which are not enforced by operating system supplier policy guidelines, thus making these firmware runtime services vulnerable.

Various aspects of the disclosure reflect an appreciation that with known information handling systems, many bootloader certificate enforcement policies are vulnerable, potentially exposing vulnerable paths via which BIOS secure boot keys, like DB/DBX, can be changed without firmware knowledge. Various aspects of the disclosure reflect an appreciation that these vulnerable paths can allow entry of unauthorized binaries into secure databases (DB/DBX).

A system and method are disclosed for performing a context based bootable security policy management operation. In certain embodiments, the context based bootable security policy management operation provides a platform context aware method to dynamically create an operating system bootable ecosystem by understanding the security policy enforcement from operating system vendors.

In certain embodiments, the context based bootable security policy management operation accesses a bootable image from a remote location (e.g., from the cloud). In certain embodiments, the context based bootable security policy management operation uses a boot path cloud connect operation to securely obtain the rebuilt bootable images and corresponding certificates to enable uninterrupted boot to the operating system. In certain embodiments, the context based bootable security policy management operation provides an NPU/GPU based virtual boot by storing bootable elements (e.g., certificates, bootloaders, third party binaries, etc.) in memory to seek cloud security response before enabling the actual boot to the operating system.

In certain embodiments, the context based bootable security policy management operation provides a context aware bootable ecosystem which ensures that the system adheres to new policy enforcements without manual intervention. In certain embodiments, the context based bootable security policy management operation scales policy enforcement across thousands of systems. In certain embodiments, the context based bootable security policy management operation includes a boot path cloud connect protocol which enables uninterrupted boot to the operating system.

In certain embodiments, the context based bootable security policy management operation enables zero touch migration of an operating system bootable ecosystem across thousands of systems in a datacenter. In certain embodiments, the context based bootable security policy management operation enables uninterrupted boot to operating system and ensures a trusted ecosystem while enabling the boot. In certain embodiments, the context based bootable security policy management operation reduces the downtime and improves the user experience.

For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

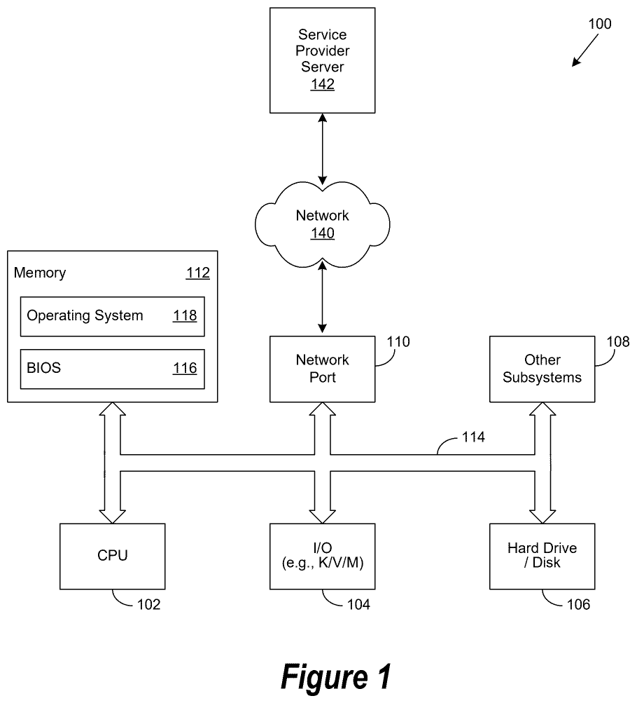

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a bootloader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an .efi file, rather than on its associated firmware. In typical implementations, the .efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein. In certain embodiments, the distributed BIOS 116 may be implemented as a distributed unified BIOS. As used herein, a distributed unified BIOS 116 broadly refers to a BIOS 116 that includes a plurality of BIOS 116 components, or a plurality of BIOS 116 variables, or a plurality of BIOS 116 storage locations, or a combination thereof, which are implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of a learning-based BIOS update operation, a context based bootable security policy management operation, or a combination thereof. In various embodiments, the learning-based BIOS update operation may be implemented to include the performance of the context based bootable security policy management operation.

A learning-based BIOS update operation, as used herein, broadly refers to any function, task, procedure, or process performed, directly or indirectly, within a multi-processor operating environment, or an architecture-specific distributed firmware management platform (ASDFMP), both of which are described in greater detail herein, to generate, instantiate, secure, distribute, provision, authenticate, implement, modify, update, replace, monitor, or manage, or a combination thereof, to determine whether any BIOS updates are available and if so to update the BIOS during a first power on of an information handling system. In various embodiments, one or more learning-based BIOS update operations may be performed to update particular processor environment specific BIOS 116 components without necessitating the update of other processor environment specific BIOS 116 components. A context based bootable security policy management operation, as used herein, broadly refers to any function, task, procedure, or process performed, directly or indirectly, within a multi-processor operating environment, or an architecture-specific distributed firmware management platform (ASDFMP), both of which are described in greater detail herein, to generate, instantiate, secure, distribute, provision, authenticate, implement, modify, update, replace, monitor, or manage, or a combination thereof, to update a BIOS of an information handing system while conforming to predefined operating system supplier policy guidelines. In various embodiments, one or more context based bootable security policy management operations may be performed to update particular security related processor environment specific BIOS 116 components without necessitating the update of other security related processor environment specific BIOS 116 components. In certain embodiments, the firmware management operation may be performed during operation of an IHS 100. In various embodiments, performance of the firmware management operation may result in the realization of improved operation of an IHS 100.

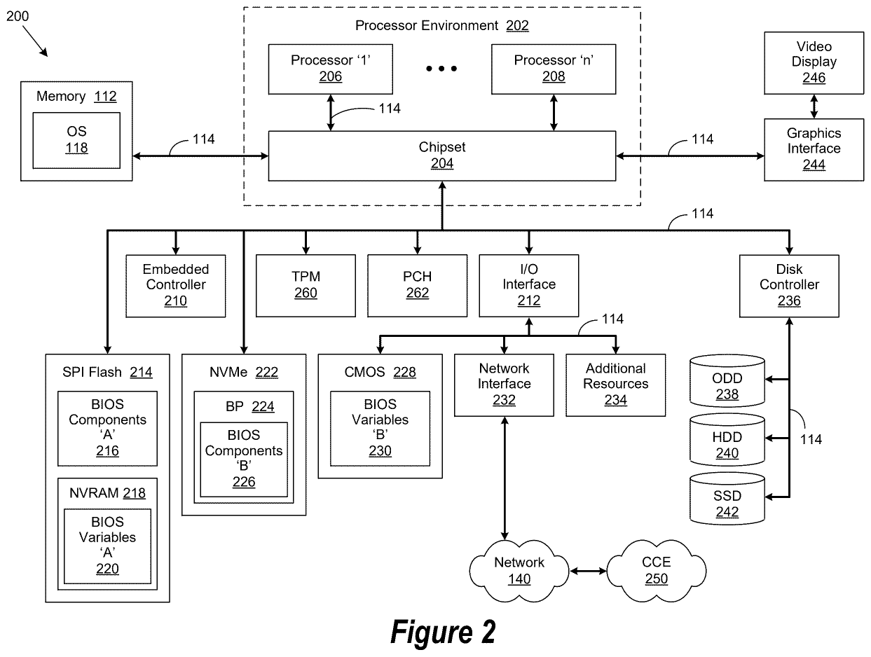

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux®.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a bootloader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

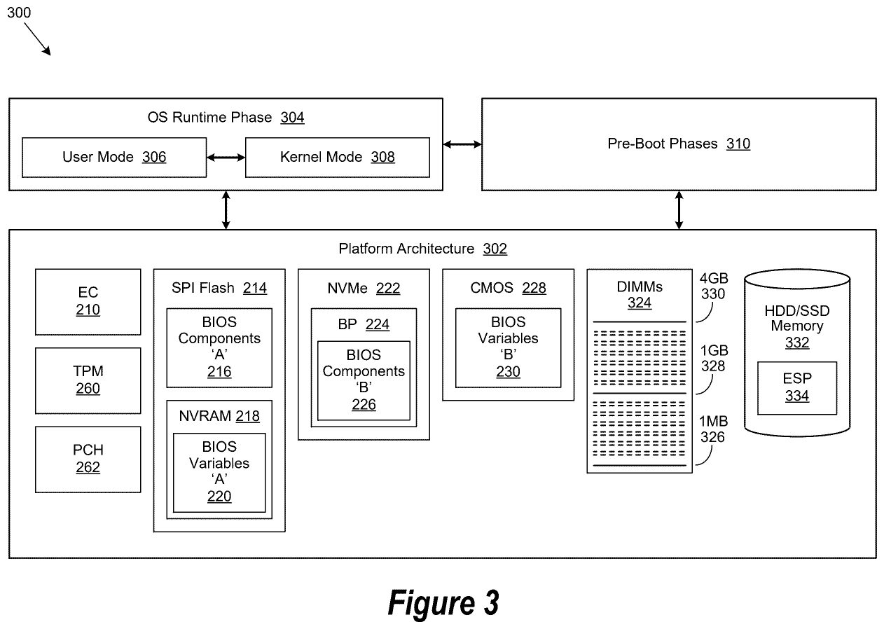

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom®, Broadcom®, NVidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel® to control certain data paths and support functions used in conjunction with Intel® processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel®, AMD®, Qualcomm®, Broadcom®, NVidia®, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1GB 328 to 4GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the bootloaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

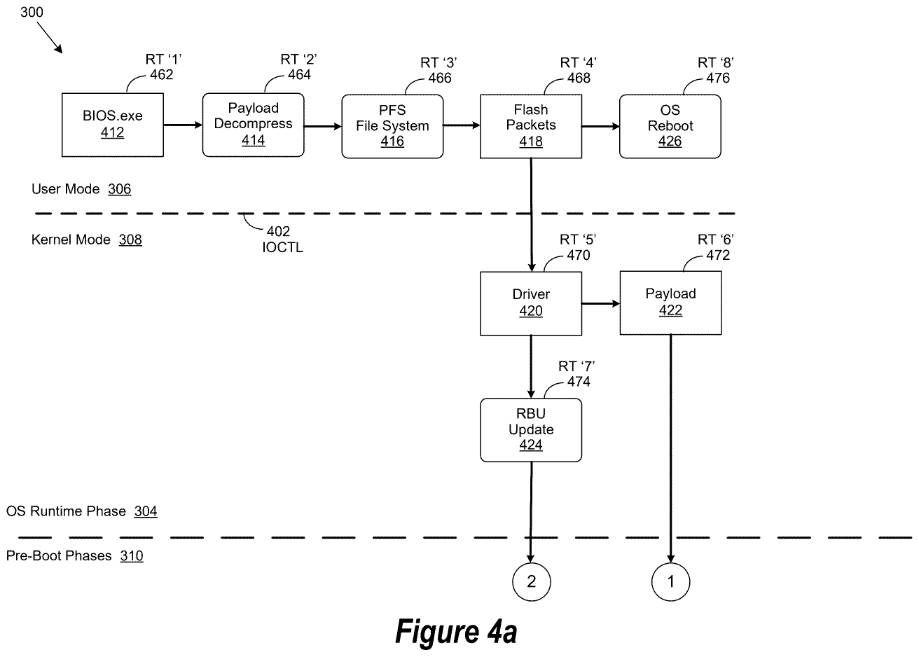

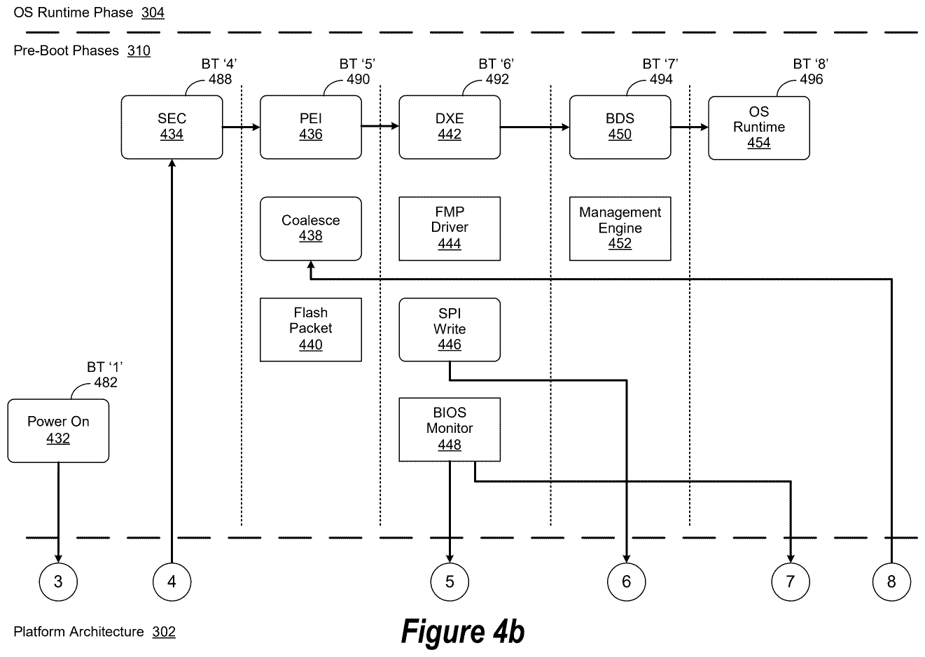

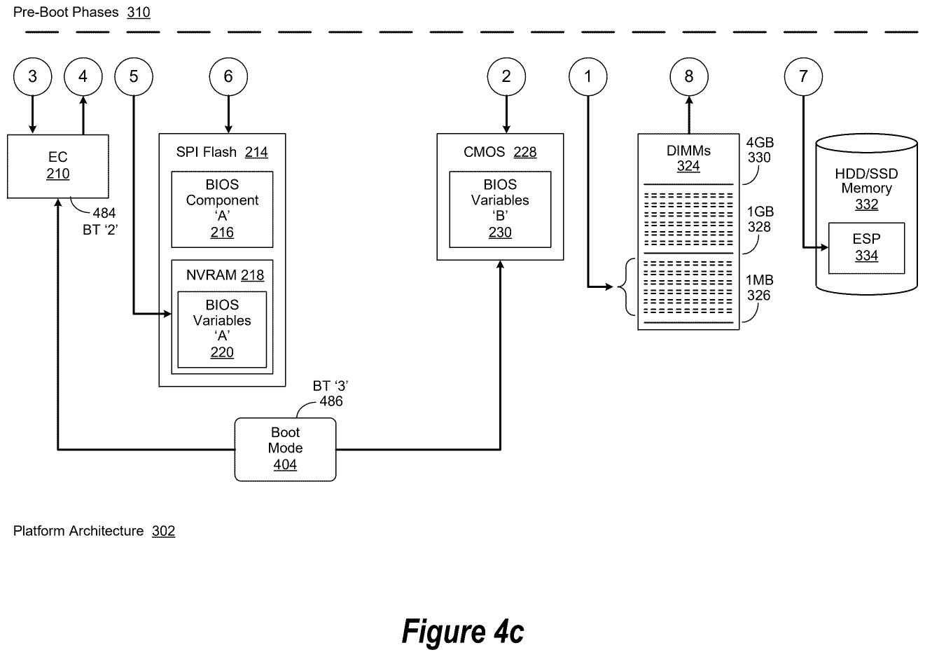

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or bootloaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one or more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6′ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel® Corporation of Santa Clara, California, may be implemented to use the selected boot device in BT step ‘8’ 496 to boot the ASDFMP 300 into an OS runtime 454 state.

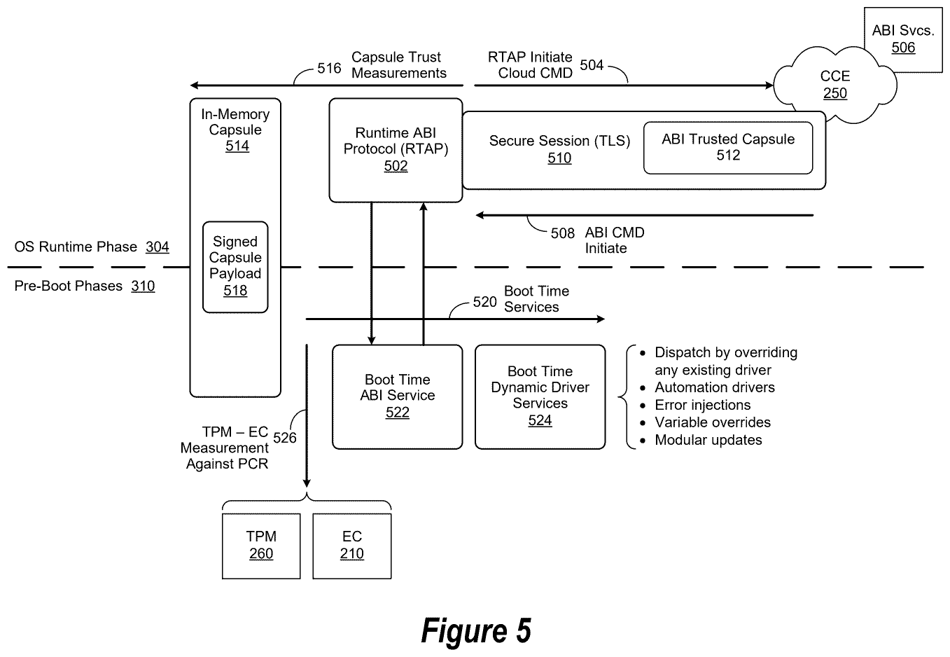

FIG. 5 is a simplified block diagram of Authenticated Basic Input/Output System (BIOS) Interface (ABI) services implemented within a cloud computing environment in accordance with an embodiment of the invention. Various embodiments of the invention reflect an appreciation that running learning models on client devices has become more common as artificial intelligence (AI) evolves. Likewise, various embodiments of the invention reflect an appreciation that large learning models (LLMs) have traditionally been deployed on powerful server infrastructures due to their extensive computational requirements.

However, various embodiments of the invention reflect an appreciation that deploying LLMs on client devices may provide certain advantages, such as a more personalized user experience, faster remediation, more immediate support, more robust data privacy, and so forth. Accordingly, an AI-capable intelligent Basic Input/Output System (BIOS), incorporating advanced algorithms and machine learning capabilities to enhance its functionality, may be implemented in various embodiments. In various embodiments, this intelligent BIOS may be implemented to autonomously detect, diagnose, and remediate issues without human intervention and provide adaptive performance and predictive maintenance.

Likewise, an eXtensible Host Controller Interface (XHCI), described in greater detail herein, may be implemented in various embodiments to improve system speed, power efficiency, and virtualization. Various embodiments of the invention likewise reflect an appreciation that typical storage capacities of portable devices have been increasing over time, with a concomitant need for high performance interfaces so they can be loaded in a reasonable amount of time. Accordingly, the implementation of an xHCI in various embodiments may reduce, or even eliminate, host memory-based transaction schedules, while its support for advanced power management features may likewise provide more power efficient platforms without sacrificing performance.

In various embodiments, the enablement of certain xHCI virtualization features may likewise allow direct assignment of individual Universal Serial Bus (USB) devices to any virtual machine (VM), irrespective of their location within a particular bus topology, to minimize run-time inter-VM communications, and provide support for native USB device sharing, or a combination thereof. Likewise, the implementation of an AI-capable intelligent BIOS in various embodiments may enable support of heterogeneous System on Chip (SoC) vendors, such as Intel®, AMD®, Qualcomm®, NVIDIA®, and so forth. The implementation of an AI-capable intelligent BIOS in various embodiments may likewise enable seamless interdependent updates services for a system's operating system (OS) and firmware. Likewise, the implementation of an intelligent cache in various embodiments may allow one or more Graphics Processing Units (GPUs), Neural Processing Units (NPUs), Accelerated Processing Units (APUs), or a combination thereof, to be leveraged to process AI workloads while supporting host embedded controller (EC) 210 side-band interrupts.

Referring now to FIG. 5, a runtime authenticated BIOS interface (ABI) protocol (RTAP) 502 may be implemented in various embodiments during a system's OS runtime phase 304. In various embodiments, the RTAP 502 may be implemented to initiate an RTAP cloud command (CMD) 504 to access certain ABI services 506, which in certain embodiments may be implemented within a cloud computing environment (CCE) 250, described in greater detail herein. In various embodiments, initiation of the RTAP cloud CMD 504 may result in certain ABI services 506 initiating an ABI CMD 508 in response.

In various embodiments, initiation of the ABI CMD 508 may result in establishing a secure session 510 between the RTAP 502 and the ABI services 506. In various embodiments, the Transport Layer Security (TLS) protocol, familiar to skilled practitioners of the art, may be used to establish the secure session 510 between the RTAP 502 and the ABI services 506. In various embodiments, the secure session 510 may be implemented to allow the ABI services 506 to provide an ABI trusted capsule 512 to the RTAP 502.

In various embodiments, the RTAP 502 may be implemented to load the ABI trusted capsule 512 into system memory as an in-memory capsule 514. In various embodiments, the RTAP 502 may likewise be implemented to perform certain capsule trust measurements 516. Likewise, the RTAP 502 may be implemented in various embodiments to generate a digitally-signed capsule payload 518.

In various embodiments, the RTAP 502 may be implemented to use the contents of the digitally-signed capsule payload 518 to create certain boot time services 520 for use during various pre-boot phases 310. In various embodiments, the boot time services 520 may include a boot time ABI service 522 and one or more boot time dynamic driver services 524. In various embodiments, the boot time ABI service 522 may be implemented to perform certain Trusted Platform Module (TPM) 260 and Embedded Controller (EC) 210 comparisons and measurements 526 against the system's Platform Configuration Register (PCR). In various embodiments the one or more boot time dynamic driver services 524 may be implemented to provide various functionalities, such as performing a dispatch by overriding any existing driver, initiating one or more automation drivers, initiating one or more error injections, performing one or more variable overrides, performing one or more modular updates, and so forth.

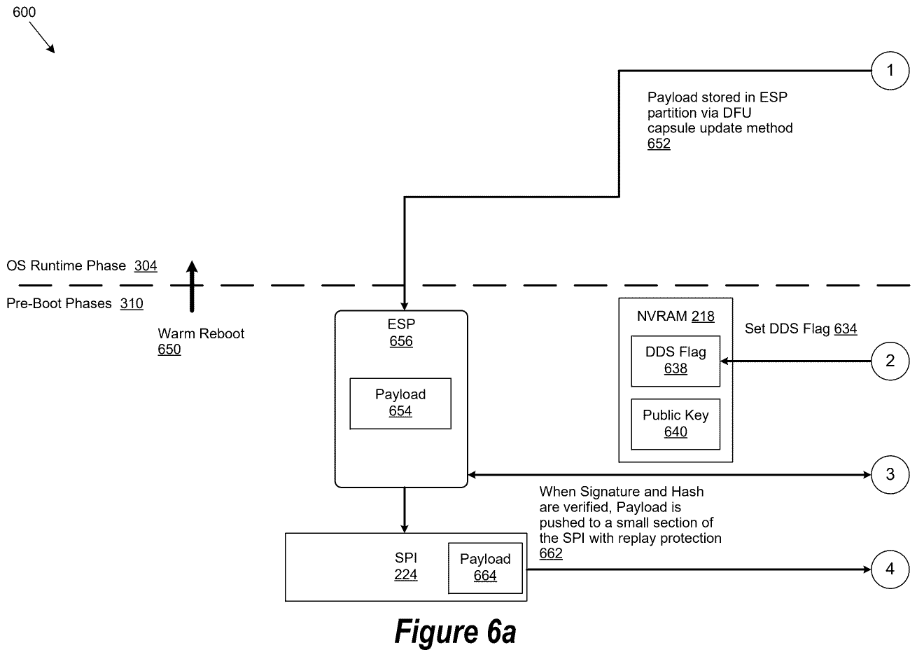

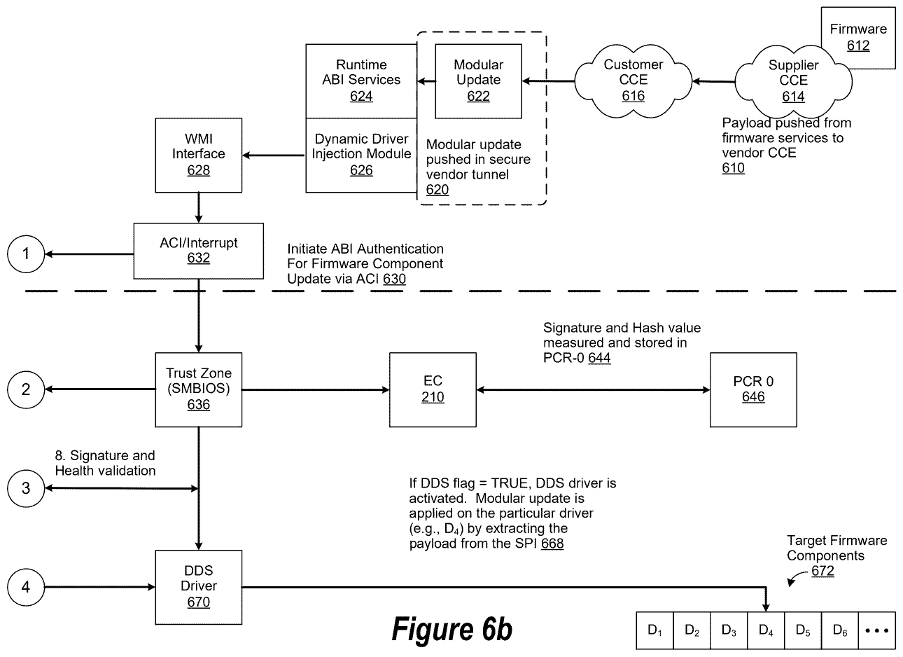

FIGS. 6a and 6b, generally referred to as FIG. 6, are a simplified process flow diagram of a learning-based BIOS update operation 600. In certain embodiments, the learning-based BIOS update operation executes on a CFI type information handling system. As used herein, a CFI type information handling system broadly refers to an information handling system which is configured and fabricated according to a configuration which conforms to predetermined information handling system configuration which is associated with an order for a plurality of information handling systems from a particular customer.

In certain embodiments, the learning-based BIOS update operation uses an artificial intelligence (AI) powered smart BIOS. In certain embodiments, the AI powered smart BIOS addresses the CFI issue by automatically connecting a CFI type information handling system to the cloud during the first power on to check for any modular updates. The BIOS connects to the cloud before the system boots to the operating system and checks if there are any modular updates/patches that are available for the equivalent BIOS version or higher. If found, no forced update needs to occur and only the needed patches/modular updates are applied to the current firmware to ensure that the system is fully up to date.

In certain embodiments, when performing the learning-based BIOS update operation, an enterprise system (e.g., a CFI type information handling system) connects to the cloud before the system boots to the operating system with the help of a light network stack. Next, the system checks the cloud for any pending modular updates for a version that is equivalent to the current BIOS version. Next, the system only checks for the patches equivalent to the BIOS of the enterprise system. If any update is pushed by the system supplier, a lightweighted modular update is pushed to the system and is used to boot the system.

In certain embodiments, a firmware CFI learning model connects to the CFI type information handling system. During the system lifecycle, the firmware CFI learning model identifies the factory shipped BIOS version, all firmware updates, security updates, etc. A smart CFI Firmware module prepares a smart update mechanism before the first power-on to the operating system. By incorporating all stable modular updates into the CFI type information handling system before the system boots to the operating system, the learning-based BIOS update operation ensures a seamless and secure user experience. Such a proactive approach significantly mitigates risks associated with outdated firmware and enhances the overall robustness and reliability of the system.

In certain embodiments, a cloud learning model identifies released firmware components and prepares the system with a custom bridge to fix vulnerabilities, potentially compromising the platform boot and recovering especially when some vulnerabilities block subsequent firmware updates.

In certain embodiments, when performing the learning-based BIOS update operation, an enterprise system (e.g., a CFI type information handling system) connects to the cloud before the system boots to the operating system with the help of a network stack. Next, the system checks the cloud for any pending modular updates for a version that is equivalent to the current BIOS version. Next, the system only checks for the patches equivalent to the BIOS of the enterprise system. If any update is pushed by the system supplier, a lightweighted modular update is pushed to the system and is used boot the system.

In certain embodiments, a firmware CFI learning model connects to the CFI, During the system lifecycle, the firmware CFI learning model identifies the factory shipped BIOS version, all firmware updates, security updates, etc. A smart CFI Firmware module prepares a smart update mechanism before the first power-on to the operating system (OS). By incorporating all stable modular updates into the platform before the system boots to the OS, the learning-based BIOS update operation ensures a seamless and secure user experience. Such a proactive approach significantly mitigates the risks associated with outdated firmware and enhances the overall robustness and reliability of the system.

In certain embodiments, a cloud learning model identifies released firmware components and prepares the system with a custom bridge to fix vulnerabilities, potentially compromising the platform boot and recovering especially when some vulnerabilities block subsequent firmware updates.

Referring now to FIGS. 6a and 6b, a learning-based BIOS update operation 600 starts at step 610 when a firmware update payload 612 from a supplier storage location 614 is pushed to a customer storage location 616. In certain embodiments, the supplier storage location 612 includes a supplier cloud computing environment (CCE). In certain embodiments, the customer storage location 616 includes a customer cloud computing environment (CCE). Next at step 620, a modular firmware update 622 is pushed to a customer information handling system. In certain embodiments, the customer information handling system includes a CFI type information handling system. In certain embodiments, the modular firmware update 622 is pushed via a runtime ABI service 624 and a dynamic driver injection module 626. In certain embodiments, the modular firmware update 622 is provided to the customer information handling system via an operating system interface such as a Windows Management Instrumentation (WMI) interface 628.

Next, at step 630, the learning-based BIOS update operation 600 initiates an Authenticated Basic Input/Output System (BIOS) Interface (ABI) authentication operation for the firmware components contained within the module firmware update 622. As used herein, an ABI authentication operation broadly refers to a firmware management operation, described in greater detail herein, performed directly, or indirectly, within a multi-processor operating environment 200 to authenticated BIOS interface service to authenticate an updated firmware component. In certain embodiments, the ABI authentication operation is initiated via an interrupt 632 such as an advanced calling interface (ACI) type interrupt. Next at step 634, the learning-based BIOS update operation 600 sets a driver flag such as a dynamic driver service (DDS) flag. In certain embodiments, the distributed unified BIOS includes a dynamic driver service. In certain embodiments, the dynamic driver service automatically loads and updates of specific firmware components of a BIOS update. In certain embodiments, the embedded controller 210 establishes a trust zone 636. In certain embodiments, the learning-based BIOS update operation 600 uses the trust zone 636 when updating a firmware component of the distributed unified BIOS. In certain embodiments, the learning-based BIOS update operation 600 uses the trust zone 636 when setting the driver flag. In certain embodiments, for certain types of processor environments, the trust zone is maintained within a system management BIOS (SMBIOS) storage location. In certain embodiments, the driver flag 638 is a BIOS variable which is stored within NVRAM 218. In certain embodiments, the driver flag 638 includes an associated public key 640. In certain embodiments, the driver flag 638 includes the DDS flag.

Next at step 644, a signature and hash value for the driver component is measured and stored within a register 646. In certain embodiments, the register 646 includes a platform configuration register (PCR). In certain embodiments, the signature and hash value are generated by the embedded controller 210 according to the trust zone established by the embedded controller 210. In certain embodiments, the register 646 is maintained within a TPM 260.

Next, at step 650, the learning-based BIOS update operation 600 performs a warm reboot of the customer information handling system and at step 652, learning-based BIOS update operation 600 stores an update payload 654 on the customer information handling system. In certain embodiments, the payload 654 is stored within a partition 656 of memory. In certain embodiments, the partition 656 of memory includes an Extensible Firmware Interface (EFI) System Partition (ESP).

Next, at step 660, the learning-based BIOS update operation 600 validates the signature and the hash of the payload 654 stored within the partition 656. Next at step 662, when the signature and hash are verified, the learning-based BIOS update operation 600 pushes the payload to the SPI 224. In certain embodiments, the payload is stored within a section of the SPI 224 with replay protection 664.

Next at step 668, the learning-based BIOS update operation 600 determines whether the DDS flag is TRUE. If so, then the driver update 670 is applied to a target firmware component. In certain embodiments, the target firmware component 672 includes a particular driver (e.g., driver D₄). In certain embodiments, the driver update is applied to the target firmware component by extracting the driver update from the payload 664 stored in the SPI 224.

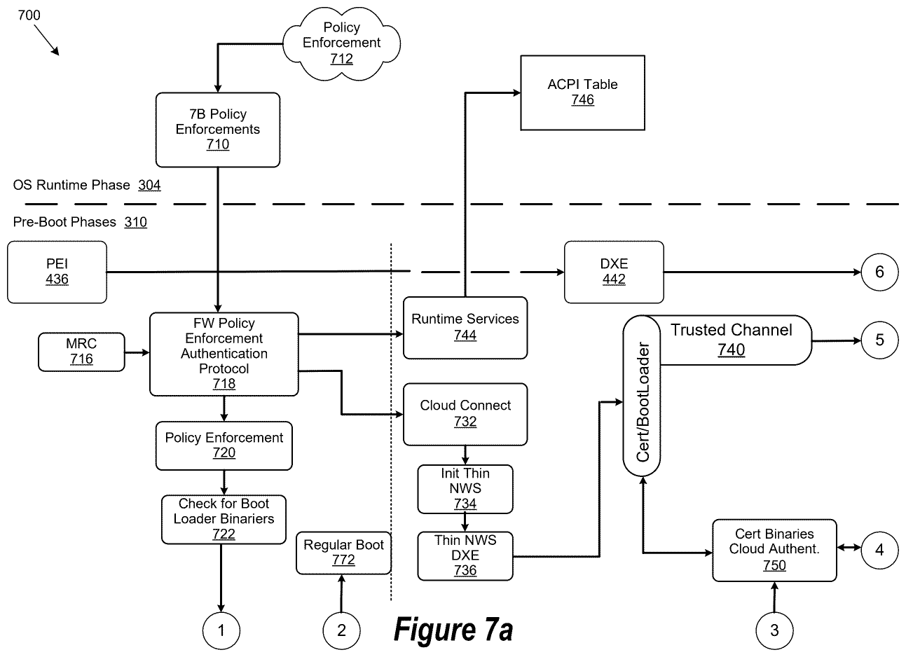

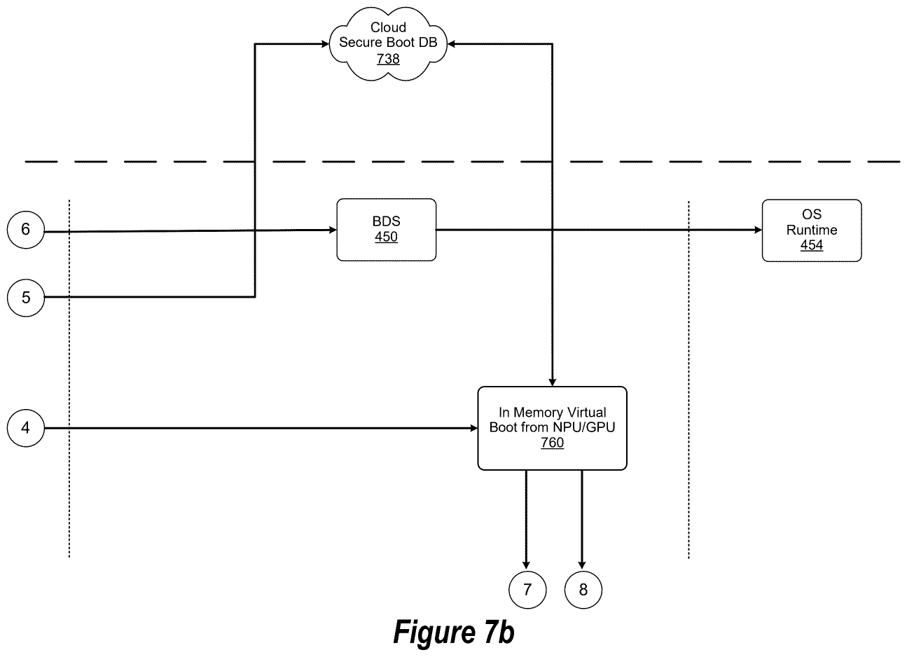

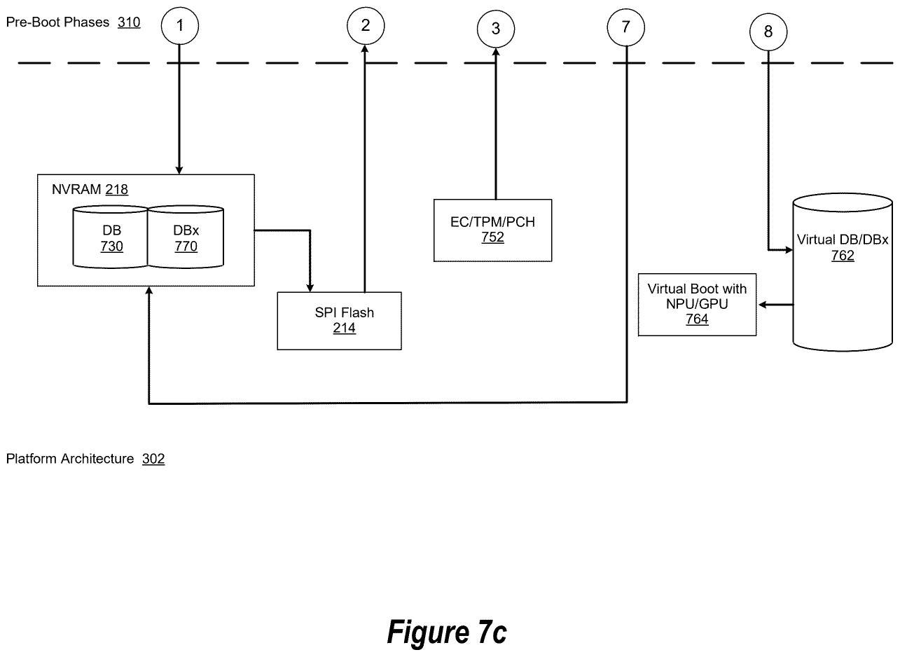

FIGS. 7a, 7b and 7c, generally referred to as FIG. 7, are a simplified process flow diagram showing a context based bootable security policy management operation 700. In certain embodiments, the learning-based BIOS update operation includes a context based bootable security policy management operation 700. In certain embodiments, the context based bootable security policy management operation provides a platform context aware method to dynamically create an operating system bootable ecosystem by understanding the security policy enforcement from operating system vendors. In certain embodiments, the context based bootable security policy management operation dynamically creates an operating system bootable ecosystem based upon an operating system vendor security policy. In certain embodiments, the operating system bootable ecosystem includes bootable operating system component and firmware component images. In certain embodiments, the bootable operating system component and firmware component images include corresponding certificates. In certain embodiments, the context based bootable security policy management operation is context aware. In certain embodiments, the context based bootable security policy management operation is processor environment agnostic

In certain embodiments, the context based bootable security policy management operation accesses a bootable image from a remote location (e.g., from the cloud). In certain embodiments, the context based bootable security policy management operation uses a boot path cloud connect operation to securely obtain the rebuilt bootable images and corresponding certificates to enable uninterrupted boot to the operating system. In certain embodiments, the context based bootable security policy management operation provides an NPU/GPU based virtual boot by storing bootable elements (e.g., certificates, bootloaders, third party binaries, etc.) in memory to seek cloud security response before enabling the actual boot to the operating system.

In certain embodiments, the context based bootable security policy management operation provides a context aware bootable ecosystem which ensures that the system adheres to new policy enforcements without manual intervention. In certain embodiments, the context based bootable security policy management operation scales policy enforcement across thousands of systems. In certain embodiments, the context based bootable security policy management operation includes a boot path cloud connect protocol which enables uninterrupted boot to the operating system.

In certain embodiments, the context based bootable security policy management operation enables zero touch migration of an operating system bootable ecosystem across thousands of systems in a datacenter. In certain embodiments, the context based bootable security policy management operation enables uninterrupted boot to operating system and ensures a trusted ecosystem while enabling the boot. In certain embodiments, the context based bootable security policy management operation reduces the downtime and improves the user experience.

Referring now to FIGS. 7a, 7b and 7c, the context based bootable security policy management operation 700 dynamically detects policy enforcement and security adoptions and dynamically creates a platform ecosystem to enable operating system boot pursuant to a most recent security policy enforcement (without compromising security). In certain embodiments, the context based bootable security policy management operation 700 provides a dynamic fallback method to determine whether policy enforcement is present and security certificate is up to date. In certain embodiments, the context based bootable security policy management operation 700 searches for new security certificates when the security certificate is not up to date. In certain embodiments, context based bootable security policy management operation 700 obtains security policies 710 from a remote storage location 712. In certain embodiments, the context based bootable security policy management operation 700 searches a USB type device for security policies, security certificates, or a combination thereof.

In certain embodiments, the context based bootable security policy management operation 700 executes during a pre-boot phase 310 of operation. In certain embodiments, the context based bootable security policy management operation 700 dynamically authenticate the secure keys to prevent any operating system bootloaders certificate or binaries issues. In certain embodiments, the context based bootable security policy management operation 700 enables system suppliers to update the operating system and install pre boot patches according to operating system supplier security policies. In certain embodiments, the operating system supplier security policies include 7B operating system security policies. As used herein, a 7B operating system security policy broadly refers to a set of security guidelines within an organization's security policy that outlines how to manage and protect the operating system on information handling systems of the organization.

In certain embodiments, the context based bootable security policy management operation 700 accesses memory reference code (MRC) 716 of a distributed unified BIOS of the information handling system. In certain embodiments, the context based bootable security policy management operation 700 provides a firmware policy enforcement authentication protocol 718 which detects operating system updates, bootloaders, and security policies available for a particular information handling system. As used herein, a firmware policy enforcement authentication protocol broadly refers to a set of rules for formatting and processing data associated with performance of a firmware policy enforcement authentication operation, described in greater detail herein. As used herein, a firmware policy enforcement authentication operation broadly refers to a firmware management operation, described in greater detail herein, performed directly, or indirectly, within a multi-processor operating environment 200 to detect and authenticate operating system updates, bootloaders, and security policies available for a particular information handling system. In certain embodiments, the memory reference code accesses the firmware policy enforcement authentication protocol 718 to perform the firmware policy enforcement authentication. In certain embodiments, the firmware policy enforcement authentication operation analyzes the information handling system to determine security compliance with policy enforcement 720 and analyzes the information handling system to conform security compliance with bootloaders and binaries 722. In certain embodiments, the operation accesses the NVRAM 218 when analyzing the information handling system. In certain embodiments, the firmware policy enforcement authentication analyzes BIOS variables maintained within the NVRAM 218 when analyzing the information handling system. In certain embodiments, the firmware policy enforcement authentication operation accesses a platform secure database 730 maintained within the NVRAM 218 when analyzing the information handling system.

In certain embodiments, based on the contents of the platform secure database 730, the context based bootable security policy management operation 700 initiates a cloud connection 732 by initializing a thin UEFI network stack 734 and accessing the thin network stack 736 to connect with a cloud secure database 738. In certain embodiments, the context based bootable security policy management operation 700 creates a secure trust channel 740 for accessing new bootloaders and certificates stored within a cloud secure database 734. In certain embodiments, the firmware policy enforcement authentication operation executes runtime services 744. In certain embodiments, the runtime services 744 access an ACPI table 746. In certain embodiments, the ACPI table 746 maintains information associated with runtime security certificates and bootloaders.

In certain embodiments, the new bootloaders and certificates are authenticated by a trusted ABI service 750 in pre-boot phase. In certain embodiments, the trusted ABI service 750 is trusted via a trust zone 752. In certain embodiments, the trust zone 752 is provided via an embedded controller 210, a TPM 260, a PCH 262, or a combination thereof.

In certain embodiments, the context based bootable security policy management operation includes an in memory virtual boot module 760 which creates a virtual secure DB/DBX database 762, applies the new cloud certificates and bootloaders to virtual secure database. In certain embodiments, the context based bootable security policy management operation 700 enables NPU/GPU based virtual boot 764 by storing bootable elements (e.g., certificates, bootloaders, third party binaries, etc.) in memory to seek cloud security response before enabling the actual boot to the operating system.

In certain embodiments, the in memory pre boot module 760 executes the system via a virtual boot. In certain embodiments, the virtual boot provides the system with new certificates and bootloaders. In certain embodiments, the new certificates and bootloaders are stored within the NVRAM 218. In certain embodiments, the new certificates and bootloaders are stored within an updated NVRAM secure database 770 of the NVRAM 218.

In certain embodiments, the context based bootable security policy management operation 700 determines whether a predetermined success threshold is met before updating the system. In certain embodiments, the predetermined success threshold is met when the system response is greater than 80%. In certain embodiments, when predetermined success threshold is met, the context based bootable security policy management operation 700 updates the NVRAM secure database 770, the SPI flash 214, or a combination thereof, seamlessly to all connected platforms. In certain embodiments, the context based bootable security policy management operation 700 performs a regular boot operation 772 to boot the information handling system once the security policies and bootloaders are updated.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed unified BIOS;
identifying a processor environment installed on an information handling system from a plurality of processor environments, the processor environment comprising a processor architecture; and,
performing a learning-based BIOS update operation, the learning-based BIOS update operation determining whether a BIOS update is available and if so updating the distributed unified BIOS during a first power on of the information handling system, the learning-based BIOS update operation being processor environment agnostic.

2. The method of claim 1, wherein:
the learning-based BIOS update operation includes an authenticated BIOS interface (ABI) authentication operation, the ABI authentication operation using an authenticated BIOS interface service to authenticate an updated firmware component.

3. The method of claim 1, wherein:
the learning-based BIOS update operation uses a dynamic driver service to update a firmware component of the BIOS update.

4. The method of claim 1, wherein:
the information handling system includes an embedded controller, the embedded controller establishing a trust zone; and,
the learning-based BIOS update operation uses the trust zone when updating the distributed unified BIOS.

5. The method of claim 1, wherein:
the learning-based BIOS update operation includes performing a context based bootable security policy management operation, the context based bootable security policy management operation dynamically creating an operating system bootable ecosystem based upon an operating system vendor security policy, the context based bootable security policy management operation being context aware, the context based bootable security policy management operation being processor environment agnostic.

6. The method of claim 5, wherein:
the operating system vendor security policy includes a 7B operating system security policy.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed unified BIOS;
identifying a processor environment installed on an information handling system from a plurality of processor environments, the processor environment comprising a processor architecture; and,
performing a learning-based BIOS update operation, the learning-based BIOS update operation determining whether a BIOS update is available and if so updating the distributed unified BIOS during a first power on of the information handling system, the learning-based BIOS update operation being processor environment agnostic.

8. The system of claim 7, wherein:
the learning-based BIOS update operation includes an authenticated BIOS interface (ABI) authentication operation, the ABI authentication operation using an authenticated BIOS interface service to authenticate an updated firmware component.

9. The system of claim 7, wherein:
the learning-based BIOS update operation uses a dynamic driver service to update a firmware component of the BIOS update.

10. The system of claim 7, wherein:
the information handling system includes an embedded controller, the embedded controller establishing a trust zone; and,
the learning-based BIOS update operation uses the trust zone when updating the distributed unified BIOS.

11. The system of claim 7, wherein:
the learning-based BIOS update operation includes performing a context based bootable security policy management operation, the context based bootable security policy management operation dynamically creating an operating system bootable ecosystem based upon an operating system vendor security policy, the context based bootable security policy management operation being context aware, the context based bootable security policy management operation being processor environment agnostic.

12. The system of claim 11, wherein:
the operating system vendor security policy includes a 7B operating system security policy.

13. A non-transitory, computer-readable storage medium embodying computer program code, the computer program code comprising computer executable instructions configured for:
providing an information handling system with a distributed unified BIOS;
identifying a processor environment installed on an information handling system from a plurality of processor environments, the processor environment comprising a processor architecture; and,
performing a learning-based BIOS update operation, the learning-based BIOS update operation determining whether a BIOS update is available and if so updating the distributed unified BIOS during a first power on of the information handling system, the learning-based BIOS update operation being processor environment agnostic.

14. The non-transitory, computer-readable storage medium of claim 13, wherein:
the learning-based BIOS update operation includes an authenticated BIOS interface (ABI) authentication operation, the ABI authentication operation using an authenticated BIOS interface service to authenticate an updated firmware component.

15. The non-transitory, computer-readable storage medium of claim 13, wherein:
the learning-based BIOS update operation uses a dynamic driver service to update a firmware component of the BIOS update.

16. The non-transitory, computer-readable storage medium of claim 13, wherein:
the information handling system includes an embedded controller, the embedded controller establishing a trust zone; and,
the learning-based BIOS update operation uses the trust zone when updating the distributed unified BIOS.

17. The non-transitory, computer-readable storage medium of claim 13, wherein:
the learning-based BIOS update operation includes performing a context based bootable security policy management operation, the context based bootable security policy management operation dynamically creating an operating system bootable ecosystem based upon an operating system vendor security policy, the context based bootable security policy management operation being context aware, the context based bootable security policy management operation being processor environment agnostic.

18. The non-transitory, computer-readable storage medium of claim 17, wherein:
the operating system vendor security policy includes a 7B operating system security policy.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
